(19) United States
(12) Patent Application Publication
(10) Pub. No.: US 2025/0080535 A1
(43) Pub. Date: Mar. 6, 2025

(54) IDENTITY PROVIDER MESH NETWORKS AND RELATED APPARATUSES, SYSTEMS, AND METHODS

(71) Applicant: CDK GLOBAL, LLC, Hoffman Estates, IL (US)

(72) Inventors: Aashish Vijay Repal, Pune (IN); Winston Moses Dhanraj, Pune (IN)

(21) Appl. No.: 18/457,909

(22) Filed: Aug. 29, 2023

(51) Int. Cl. H04L 9/40; H04L 67/12

(52) U.S. Cl. CPC H04L 63/10; H04L 63/0807; H04L 67/12

(57) ABSTRACT

Identity provider (IDP) mesh networks and related systems, apparatuses, and methods are disclosed. A first software domain to participate in an IDP mesh network manages first software applications of the first software domain. A first IDP of the first software domain provides access to the first software applications of the first software domain to first users registered with the first software domain responsive to first verified login credentials provided to the first IDP. The first IDP also federates, with a second IDP of a second software domain participating in the IDP mesh network, access of the first users to second software applications of the second software domain responsive to the first verified login credentials.

### TECHNICAL FIELD

This disclosure relates generally to mesh networks of identity providers (IDPs) and related apparatuses, systems, and methods.

### BACKGROUND

In various industries it may be useful to provide multiple different software applications to users. The automobile dealership industry is one example of an industry where provisioning of multiple different software applications may be helpful. For example, automobile dealerships may benefit from different software applications for a dealer management system, finance and insurance, customer relations management, automobile insurance, and the like.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 is a block diagram of an IDP mesh network system, according to some embodiments;

FIG. 2 is a block diagram of an IDP mesh network system, which is an example of the IDP mesh network system of FIG. 1;

FIG. 3 is a flowchart illustrating a method to be implemented by a new software domain that is to be added to an IDP mesh network, according to some embodiments;

FIG. 4 is a flowchart illustrating a method that may be performed by a software domain added to an IDP mesh network, according to some embodiments;

FIG. 5 is a block diagram of a computing system, according to some embodiments; and

FIG. 6 is a block diagram of circuitry that, in some embodiments, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments enabled herein may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. In some instances similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawings could be arranged and designed in a wide variety of different configurations. Thus, the following description of various embodiments is not intended to limit the scope of the present disclosure, but is merely representative of various embodiments. While the various aspects of the embodiments may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general-purpose processor, a special-purpose processor, a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, the term “federate” refers to an IDP of one software domain interacting with another IDP of another software domain with which the IDP has a mutual trust to obtain access of the software applications managed by the other IDP of the other software domain for its own users registered with its own software domain.

As used herein, the terms “software application,” “software app,” “application,” and “app” refer to software application that may be executed in whole or in part on a user device (e.g., in an operating system environment of the user device, as a web application via a web browser of the user device, or some combination thereof).

As used herein, the term “superapp” refers to a software application that provides a platform for accessing multiple software applications (e.g., of multiple different software domains), services, and/or features.

In various industries, it may be useful to provide multiple different software applications. One example of an industry where provision of multiple different software applications may be useful is the automobile dealership industry. In the automobile dealership industry, as well as in many other industries, some of these multiple different software applications may be managed by different entities having separate IDPs to verify and provide proof of authentication. Users of these multiple different software systems may interact with the different entities separately to access these multiple different software applications, which may result in the user creating and using multiple different sets of login credentials for these multiple different IDPs.

It may be inconvenient or otherwise undesirable to users to interact with multiple different software applications separately and to keep track of multiple different sets of login credentials to access the multiple different software applications. One way to reduce the number of login credentials a user keeps track of is to use a single IDP to verify login credentials and provide proof of authentication. The single IDP may federate a user's verified identity across multiple service provider software applications. Another way to reduce the number of login credentials a user keeps track of is to use multiple identity and service providers to create a federated identity management system that uses a centralized third-party-based system to establish trust in a system.

Although these approaches may provide a more convenient user experience, it may be costly and/or disruptive to migrate software applications supported by separate IDPs to operate with a single IDP. Accordingly, adding one or more software applications having their own IDP or IDPs to a single IDP system may involve significant reprogramming to enable the one or more software applications to interact with the single IDP of the single IDP system. In some instances the expenses and delays involved with such reprogramming may delay or even prevent addition of certain desired software applications to a multiple software application platform.

Some embodiments may leverage an IDP mesh network to reduce the amount of reprogramming and/or retooling involved in adding software applications already supported by separate IDPs into a multiple software application platform. For example, a managed IDP mesh for enterprises provides seamless user authentication and access management across a diverse suite of software products and systems.

Some embodiments provide a capability to federate multiple disparate IDPs configured in a mesh model so that users may securely access software applications protected by any of the IDPs that are part of the IDP mesh with a single set of sign-on credentials. Some embodiments involve setting up full-duplex, two-way trust across multiple participant IDPs. For example, security assertion markup language 2 (SAML2) protocols may be used to establish this underlying trust network. Additional bi-directional single sign-on (SSO) endpoints and rule-driven user provisioning methods may be used to implement a single logical IDP system comprising multiple IDPs networked in a mesh for the enterprise. The IDP mesh may then support any number of service provider applications including native enterprise products, off-the-shelf third-party commercial products, or acquired custom products. The IDP mesh avoids costly and disruptive user and application migration projects to enable various software applications to be accessed via a single IDP.

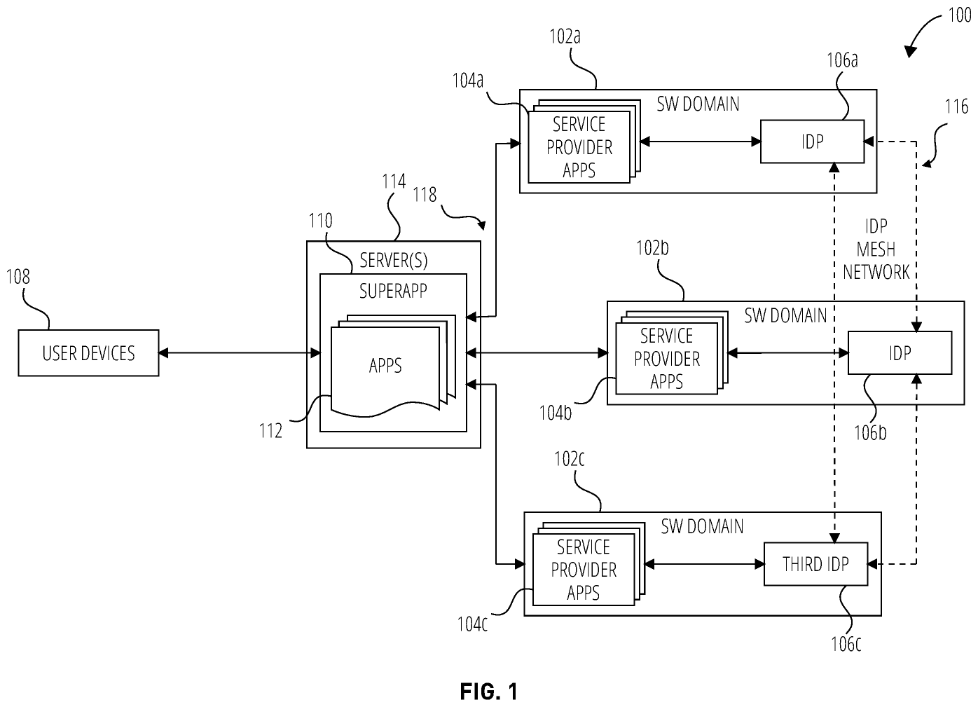

FIG. 1 is a block diagram of an IDP mesh network system 100, according to some embodiments. The IDP mesh network system 100 includes one or more servers 114, multiple software domains 102a-102c, and user devices 108. The software domains 102a-102c include service provider apps 104a-104c and IDPs 106a-106c to manage access of users at the user devices 108 to the service provider apps 104a-104c. The IDPs 106a-106c are communicatively coupled with each other in an IDP mesh network 116 to enable single sign-on (SSO) access to the service provider apps 104a-104c to users registered with any one of the software domains 102a-102c.

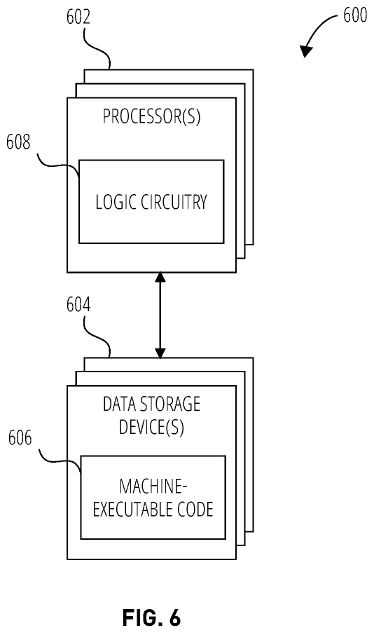

The software domains 102a-102c may include computing devices, which may include circuitry (e.g., circuitry 600 discussed below with reference to FIG. 6). For example, a first software domain 102a, a second software domain 102b, and a third software domain 102c may each include one or more processors (e.g., the processors 602 of FIG. 6) and one or more non-transitory computer-readable media (e.g., the storage 604 of FIG. 6). The one or more non-transitory computer-readable media include computer-readable instructions (e.g., the machine-executable code 606 of FIG. 6) stored thereon. The computer-readable instructions are configured to instruct the one or more processors to manage one or more software applications. Specifically, the one or more processors of the first software domain 102a manage one or more first software applications (e.g., service provider apps 104a) of the first software domain. The one or more processors of the second software domain 102b manage one or more second software applications (service provider apps 104b). The one or more processors of the third software domain 102c manage one or more third software applications (service provider apps 104c).

The one or more processors of the software domains 102a-102c may also provide access to their own respective software applications to their own respective registered users. For example, the computer-readable instructions are configured to instruct the one or more processors of the first software domain 102a to operate a first IDP 106a to provide access to the one or more first software applications (e.g., service provider apps 104a) of the first software domain 102a to first users registered with the first software domain 102a responsive to first verified login credentials provided to the first IDP 106a. The computer-readable instructions are configured to instruct the one or more processors of the second software domain 102b to operate second IDP 106b to provide access to the one or more second software applications (e.g., service provider apps 104b) of the second software domain 102b to second users registered with the second software domain 102b responsive to second verified login credentials provided to the second IDP 106b. The computer-readable instructions are configured to instruct the one or more processors of the third software domain 102c to operate third IDP 106c to provide access to the one or more third software applications (e.g., service provider apps 104c) of the third software domain 102c to third users registered with the third software domain 102c responsive to third verified login credentials provided to the third IDP 106c.

The one or more processors of the software domains 102a-102c may further operate their respective IDPs 106a-106c to federate, with other IDPs 106a-106c of the other software domains 102a-102c, access of their own respective users to the software applications of the other software domains 102a-102c. For example, the computer-readable instructions are configured to instruct the one or more processors to operate the first IDP 106a to federate, with a second IDP 106b of a second software domain 102b participating in the IDP mesh network, access of the first users to one or more second software applications (e.g., service provider apps 104b) of the second software domain 102b responsive to the first verified login credentials. Also, the computer-readable instructions are configured to instruct the one or more processors to operate the first IDP 106a to federate, with a third IDP 106c of a third software domain 102c participating in the IDP mesh network 116, access of the first users to one or more third software applications (e.g., service provider apps 104c) of the third software domain 102c responsive to the first verified login credentials. Likewise, the second IDP 106b federates, with the first IDP 106a and the third IDP 106c, access of the first software apps of the first software domain 102a and the second software applicant submits of the second software domain 102b, respectively, to the second users registered with the second software domain 102b. Further, the third IDP 106c federates, with the first IDP 106a and the second IDP 106b, access of the first software applicant submits of the first software domain 102a and the second software apps of the third software domain 102c, respectively, to the third users registered with the third software domain 102c.

The one or more processors of the software domains 102a-102c may operate their respective IDPs 106a-106c to provide access to their respective software applications to users registered with others of the software domains 102a-102c responsive to federation of the IDPs 106a-106c of the other software domains 102a-102c with their own IDPs 106a-106c. For example, the computer-readable instructions are configured to instruct the one or more processors of the first software domain 102a to provide access to the one or more first software applications (e.g., the service provider apps 104a) of the first software domain 102a to second users registered with the second software domain 102b responsive to federation of the second IDP 106b with the first IDP 106a. Also, the computer-readable instructions are configured to instruct the one or more processors of the first software domain 102a to provide access to the one or more first software applications (e.g., the service provider apps 104a) of the first software domain 102a to the third users registered with the third software domain 102c responsive to federation of the third IDP 106c with the first IDP 106a. Likewise, the one or more processors of the second software domain 102b are configured to provide access to the one or more second software applications of the second software domain 102b to the first users and the second users responsive to federation of the first IDP 106a and the third IDP 106c, respectively, with the second IDP 106b. Similarly, the one or more processors of the third software domain 102c are configured to provide access to the one or more third software applications of the third software domain 102c to the first users and the second users responsive to federation of the first IDP 106a and the second IDP 106b, respectively, with the third IDP 106c.

The servers 114 include one or more computing devices (e.g., including circuitry such as the circuitry 600 of FIG. 6). The servers 114 include a network interface 118 and one or more processors (e.g., the processors 602 of FIG. 6) communicatively coupled with the network interface. The network interface 118 enables communication with the software domains 102a-102c, which are arranged in the IDP mesh network 116. The one or more processors are configured to operate a superapp 110 to provide, to users of the user devices 108, a platform for accessing software applications provided by the software domains 102a-102c responsive to login credentials (e.g., provided by users via the user devices 108) for any one of the software domains 102a-102c. For example, a user of the user devices 108 may access, via the superapp 110, the service provider apps 104a of the first software domain 102a managed by the first IDP 106a, the service provider apps 104b of the second software domain 102b managed by the second IDP 106b, and the service provider apps 104c of the third software domain 102c managed by the third IDP 106c. The superapp 110 may also provide logged-in users access to one or more local apps 112 managed at the servers 114.

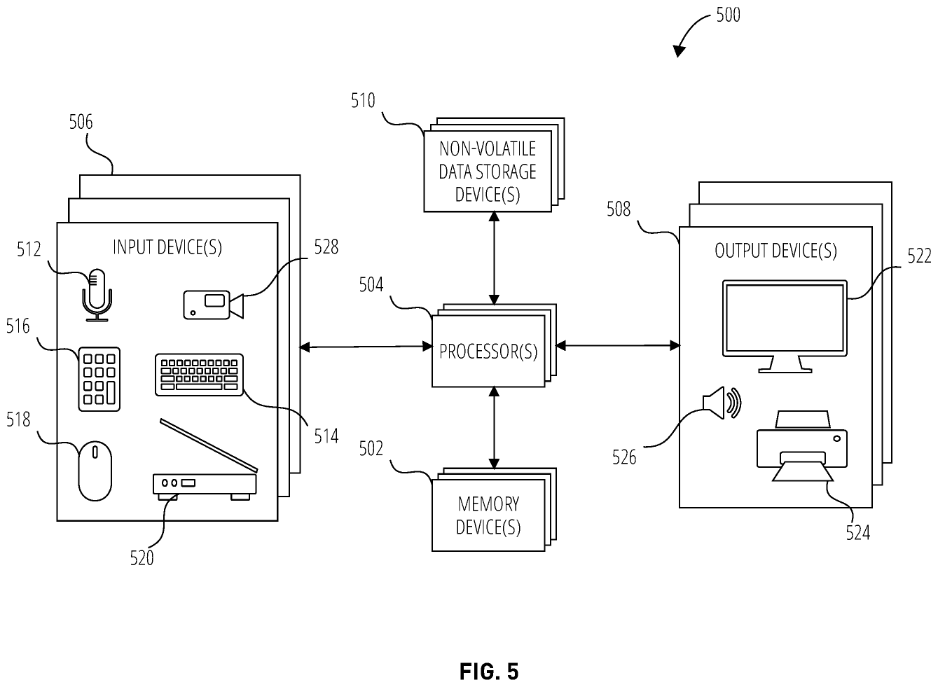

The user devices 108 may include computing systems such as the computing systems 500 of FIG. 5. The user devices 108 may include personal computers (PCs), mobile devices (e.g., tablet computers, smartphone devices, etc.), point of sale (POS) devices, or any other devices that enable users to interface with the superapp 110. In some embodiments the superapp 110 may be a web application accessed by the user devices 108 via a web browser software application executed on the user devices 108. In some embodiments the superapp 110 may be a software application provided by the servers 114 to the user devices 108 and executed by the user devices 108.

In some embodiments, users of the user devices 108 may use login credentials for one of the IDPs 106a-106c via the superapp 110 to access one of the software domains 102a-102c. By way of non-limiting example, one of the IDPs 106a-106c may (e.g., via the superapp 110) cause the user devices 108 to present a login user interface (e.g., on an electronic display 522 of FIG. 5) to the users and receive login credentials (e.g., via the input devices 506 of FIG. 5) from the users via the login user interface. Once logged in to one of the software domains 102a-102c, the IDP mesh network 116 may provide the user access to the service provider apps of the software domain the user is logged into, and to the service provider apps of the other software domains. Accordingly, the login credentials used to access any one of the IDPs 106a-106c may be treated as SSO login credentials.

In some embodiments, the IDP mesh network 116 may provide a logged-in user access to all of the service provider apps 104a-104c. In some embodiments the IDP mesh network 116 may provide the logged-in user access to only a subset of the service provider apps 104a-104c that the user is signed up for (e.g., that the user has a subscription for). The servers 114, the IDPs 106a-106c, or a combination thereof may maintain a database indicating which service provider apps 104a-104c each user is signed up for.

The different software domains 102a-102c may provide different service provider apps. For example, service provider apps 104a of first software domain 102a may include dealer management system and customer relations management software applications while service provider apps 104b of second software domain 102b may include finance and insurance software applications and service provider apps 104c of third software domain 102c may include an automobile insurance software application. In some embodiments the various software domains may offer similar, competing software applications. For example, service provider apps 104a of first software domain 102a may include a first dealer management system software application while service provider apps 104b of second software domain 102b may include a second competing dealer management system software application).

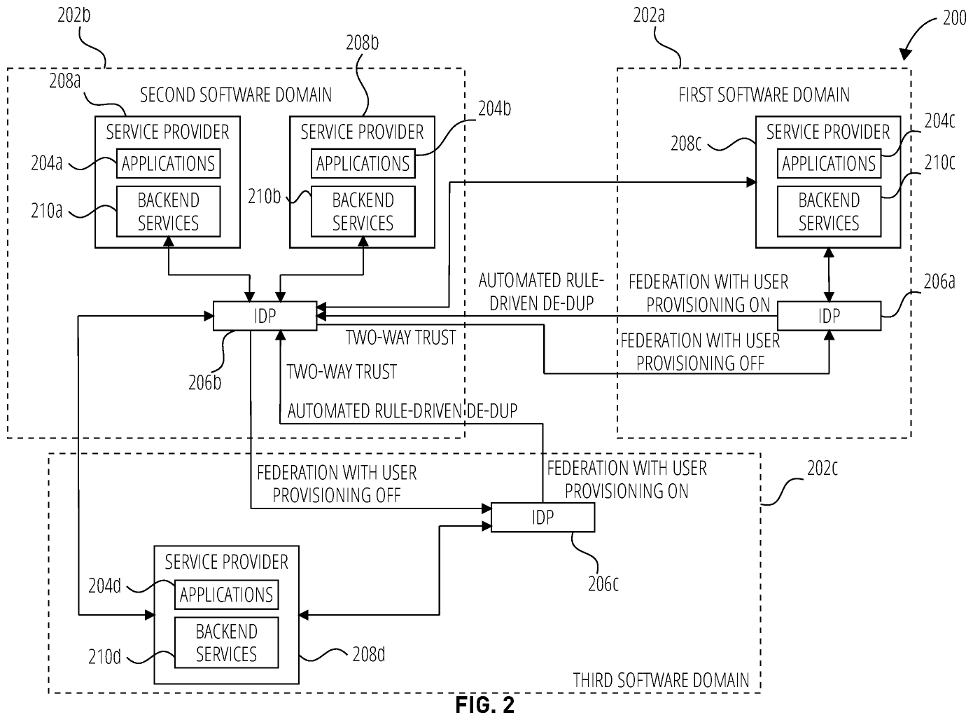

FIG. 2 is a block diagram of an IDP mesh network system 200, which is an example of the IDP mesh network system 100 of FIG. 1, according to some embodiments. The IDP mesh network system 200 includes a first software domain 202a, a second software domain 202b, and a third software domain 202c similar to the first software domain 102a, the second software domain 102b, and the third software domain 102c of FIG. 1. The first software domain 202a includes service provider 208c and a first IDP 206a similar to the IDPs 106a-106c of FIG. 1. The service provider 208c includes applications 204c similar to the service provider apps 104a-104c of FIG. 1 and backend services 210c.

The second software domain 202b includes service provider 208a, service provider 208b, and a second IDP 206b similar to the second IDP 106b of FIG. 1. The service provider 208a includes applications 204a similar to the service provider apps 104a-104c of FIG. 1 and backend services 210a. The service provider 208b includes applications 204b similar to the service provider apps 104a-104c of FIG. 1 and backend services 210b.

The third software domain 202c includes service provider 208c and a third IDP 206c similar to the IDPs 106a-106c of FIG. 1. The service provider 208d includes applications 204d similar to the service provider apps 104a-104c of FIG. 1 and backend services 210d.

Similar to the IDPs 106a-106c of FIG. 1, at least some of the IDPs 206a-206c are configured to communicate with each other in a mesh network. In the example illustrated in FIG. 2, second IDP 206b is communicatively coupled with first IDP 206a and third IDP 206c. By this communicative coupling, two-way trust is established between second IDP 206b and first IDP 206a, and between second IDP 206b and third IDP 206c. The IDP mesh network system 200 provides for automated user provisioning across mesh IDPs 206a-206c with de-duplication (“de-dup” in FIG. 2).

By way of non-limiting example, a user profile may be created and registered with first IDP 206a for first software domain 202a. The user profile may be transmitted (e.g., over a system for cross-domain identity management (SCIM)) to second IDP 206b. A rule may be defined in second IDP 206b to match user profile attributes (e.g., email address, telephone number, first name, last name, etc.). If a rule match is found (e.g., a user with matching user attributes to those of the user registered with first software domain 202a is already registered with second software domain 202b), the user profile of first software domain 202a may be linked with the matching user profile in second IDP 206b. This may reduce duplications of registered users in the software domains 202a-202b, resulting in automated rule-driven de-dup. If no rule match is found, a new user profile may be created new by second IDP 206b to register the new user with the second software domain 202b. At this point, the new user may be provided access to applications 204a, 204b, and 204c at the first software domain 202a and the second software domain 202b.

In the example illustrated in FIG. 2, second software domain 202b and its second IDP 206b may operate somewhat as a master software domain in that the IDPs 206a and 206c and service providers 208c and 208d of the other software domains 202a and 202c are in communication with the second IDP 206b of the second software domain 202b. Federation of the second IDP 206b with the first IDP 206a and the third IDP 206c may be performed with user provisioning off. In contrast, federation of the first IDP 206a and the third IDP 206c with the second IDP 206b may be performed with user provisioning on.

The example of FIG. 2 illustrates that IDP mesh networks according to various embodiments of the disclosure may be implemented in various flexible ways. In some embodiments, one or more software domains may be implemented as master software domains (e.g., their IDP being communicatively coupled to multiple IDPs and multiple service providers of multiple different other software domains with federation with user provisioning on in the direction toward the master software domain and user provisioning off in the direction away from the master software domain). In some embodiments, the IDPs of all software domains may be communicatively coupled with the IDPs and service providers of all of the other software domains in a master-less architecture configuration (e.g., with user provisioning on in all directions). It is contemplated within the scope of the disclosure that user provisioning in different directions between IDPs may be flexibly turned on or off, and new software domains may be added or existing software domains may be removed or reconfigured.

FIG. 2 also illustrates that different ones of software domains may include different numbers of service providers that each include their own software applications and backend services. For example, second software domain 202b of FIG. 2 includes two service providers (service provider 208a and service provider 208b) while first software domain 202a includes one service provider (service provider 208c) and third software domain 202c includes one service provider (service provider 208d). In some embodiments a software domain may include more than two service providers (not shown).

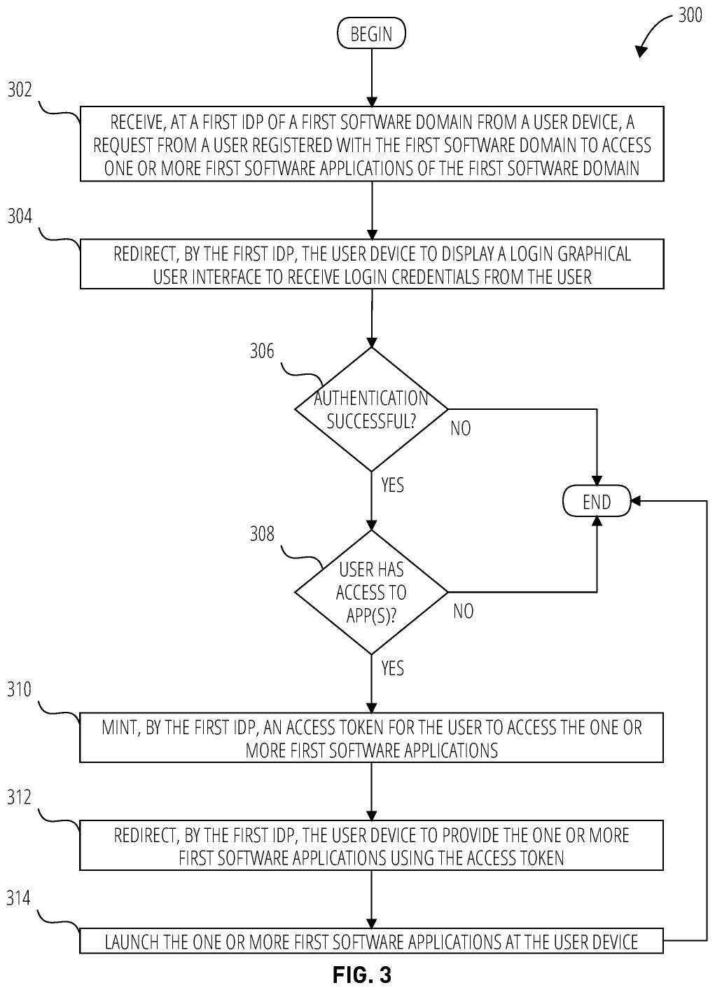

Addition of a new software domain into an IDP mesh network such as those illustrated in FIG. 1 and FIG. 2 with its own separate IDP may be relatively simple as compared to retooling a new software domain to be managed by an existing single IDP without an IDP mesh network. FIG. 3 illustrates a flowchart of operations that may be implemented into a new IDP of a new software domain in order to add the new software domain into an existing IDP mesh network. This flowchart of operations is relatively simple and easy to implement, and may be completed on the order of days or weeks instead of on the order of months and years, which may be the timeline of retooling the new software domain to operate under a single IDP of a system that does not include an IDP mesh network according to various embodiments of the disclosure.

FIG. 3 is a flowchart illustrating a method 300 to be implemented by a new software domain that is to be added to an IDP mesh network, according to some embodiments. The method 300 may be a method to access, by a user registered with a first software domain, service provider software applications managed by the owning IDP of the first IDP. At operation 302, method 300 includes receiving, at a first IDP of a first software domain from a user device, a request from a user registered with the first software domain to access one or more first software applications of the first software domain. At operation 304, method 300 includes redirecting, by the first IDP, the user device to display a login graphical user interface to receive login credentials from the user.

At decision 306, the first IDP determines whether the authentication was successful (e.g., whether the login credentials received at the user device match registered login credentials stored for the registered user). If the authentication was not successful (NO), the method 300 may end. If, however, the authentication was successful (YES), the method 300 may proceed to decision 308, which includes determining whether the user has access to the one or more requested first software applications. If the user does not have access to the one or more requested software applications (NO), the method 300 may end. If, however, the user does have access to the one or more requested software applications (YES), the method 300 may proceed to operation 310. At operation 310, the method 300 includes minting, by the first IDP, an access token for the user to access the one or more requested first software applications.

At operation 312, the method 300 includes redirecting, by the first IDP, the user device to provide the one or more requested first software applications using the access token. At operation 314, the method 300 includes launching the one or more requested first software applications at the user device. The user thus accesses the one or more requested first software applications as per access provision.

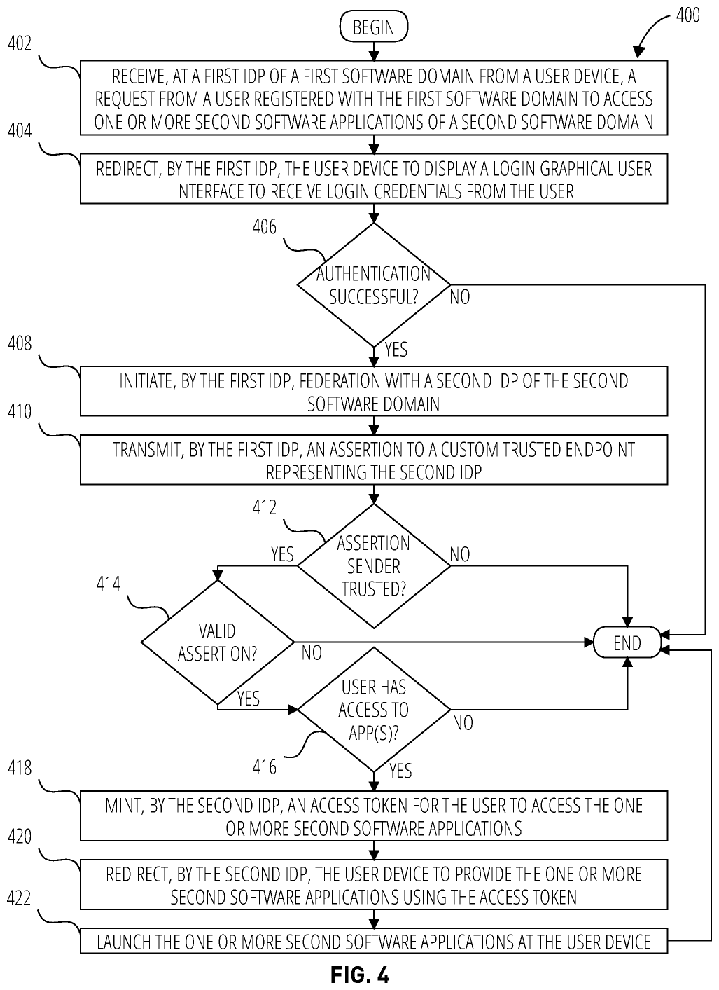

A software domain that is thus configured to operate according to the method 300 of FIG. 3 may be capable of being added to an existing IDP mesh network according to various embodiments disclosed herein. FIG. 4 illustrates a method 400 that may be performed by such a software domain that implemented the method 300 of FIG. 3 and was subsequently added to an IDP mesh network.

FIG. 4 is a flowchart illustrating a method 400 that may be performed by a software domain added to an IDP mesh network, according to some embodiments. Using the method 400, a user registered with a first software domain may access service provider software applications managed by any other IDP in the IDP mesh network. At operation 402 the method 400 includes receiving, at a first IDP of a first software domain from a user device, a request from a user registered with the first software domain to access one or more second software applications of a second software domain. Accordingly, the user initiates sign-in with the owning IDP of the software domain that the user is registered with. At operation 404 the method 400 includes redirecting, by the first IDP, the user device to display a login graphical user interface to receive login credentials from the user.

At decision 406 the method 400 includes determining whether the authentication was successful. If the authentication was not successful (NO), the method 400 may end. If, however, the authentication was successful (YES), the method 400 may proceed to operation 408. At operation 408 the method 400 includes initiating, by the first IDP, federation with a second IDP of the second software domain. For example, the owning IDP (the first IDP) of the software domain the user is registered with (the first IDP) may initiate a federated SAML exchange with encrypted user assertion with external IDP (the second IDP of the second software domain) (e.g., to target the one or more second software applications managed by the second IDP).

At operation 410 the method 400 includes transmitting, by the first IDP, an assertion (e.g., a SAML assertion) to a custom trusted endpoint representing the second IDP. At decision 412 the method 400 includes determining, by custom trusted endpoint representing the second IDP, whether the assertion sender (the first IDP of the first software domain) is trusted. If the assertion sender is determined to not be trusted (NO), the method 400 may end. If, however, the assertion sender is determined to be trusted (YES), the method 400 proceeds to decision 414. Accordingly, the external IDP (the second IDP) validates the SAML-based user assertion based, at least in part, on pre-configured mutual trust between the first IDP and the second IDP.

At decision 414 the method 400 includes determining, by the custom trusted endpoint representing the second IDP, whether the assertion was a valid assertion. If the assertion is determined to not be a valid assertion (NO), the method 400 may end. If, however, the assertion is determined to be a valid assertion (YES), the method 400 proceeds to decision 416.

At decision 416 the method 400 includes determining, by the custom trusted endpoint representing the second IDP, whether the user has access to the one or more requested second software applications. If it is determined that the user does not have access to the one or more requested second software applications (NO), the method 400 may end. If, however, it is determined that the user has access to the one or more requested second software applications, the method 400 proceeds to operation 418. Accordingly, the second IDP verifies that the user has access to software application features (e.g., the user has a subscription, etc.).

At operation 418 the method 400 includes minting, by the second IDP, an access token for the user to access the one or more second software applications. At operation 420 the method 400 includes redirecting, by the second IDP, the user device to provide the one or more second software applications using the access token. At operation 422 the method 400 includes launching, by the second IDP, the one or more requested second software applications at the user device.

FIG. 5 is a block diagram of a computing system 500, according to some embodiments.

The computing system 500 includes one or more processors 504 operably coupled to one or more memory devices 502, one or more non-volatile data storage devices 510, one or more input devices 506, and one or more output devices 508. In some embodiments the computing system 500 includes a personal computer (PC) such as a desktop computer, a laptop computer, a tablet computer, a mobile computer (e.g., a smartphone, a personal digital assistant (PDA), etc.), a network server, or other computer device.

In some embodiments the one or more processors 504 may include a central processing unit (CPU) or other processor configured to control the computing system 500. In some embodiments the one or more memory devices 502 include random access memory (RAM), such as volatile data storage (e.g., dynamic RAM (DRAM) static RAM (SRAM), etc.). In some embodiments the one or more non-volatile data storage devices 510 include a hard drive, a solid state drive, Flash memory, erasable programmable read only memory (EPROM), other non-volatile data storage devices, or any combination thereof. In some embodiments the one or more input devices 506 include a keyboard 514, a pointing device 518 (e.g., a mouse, a track pad, etc.), a microphone 512, a keypad 516, a scanner 520, a camera 528, other input devices, or any combination thereof. In some embodiments the output devices 508 include an electronic display 522, a speaker 526, a printer 524, other output devices, or any combination thereof.

User devices discussed herein (e.g., the user devices 108 of FIG. 1) may be or may include the computing system 500 of FIG. 1. For example, user interfaces to enable the user to interface with the software applications (e.g., the service provider apps 104a-104c, the applications 204a-204d) may be displayed by the electronic display 522 and the user may interact with the user interfaces via the input devices 506 and/or the output devices 508.

It will be appreciated by those of ordinary skill in the art that functional elements of embodiments disclosed herein (e.g., functions, operations, acts, processes, and/or methods) may be implemented in any suitable hardware, software, firmware, or combinations thereof. FIG. 6 illustrates non-limiting examples of implementations of functional elements disclosed herein. In some embodiments, some or all portions of the functional elements disclosed herein may be performed by hardware specially configured for carrying out the functional elements.

FIG. 6 is a block diagram of circuitry 600 that, in some embodiments, may be used to implement various functions, operations, acts, processes, and/or methods disclosed herein. The circuitry 600 includes one or more processors 602 (sometimes referred to herein as “processors 602”) operably coupled to one or more data storage devices (sometimes referred to herein as “storage 604”). The storage 604 includes machine-executable code 606 stored thereon and the processors 602 include logic circuitry 608. The machine-executable code 606 includes information describing functional elements that may be implemented by (e.g., performed by) the logic circuitry 608. The logic circuitry 608 is adapted to implement (e.g., perform) the functional elements described by the machine-executable code 606. The circuitry 600, when executing the functional elements described by the machine-executable code 606, should be considered as special-purpose hardware configured for carrying out functional elements disclosed herein. In some embodiments the processors 602 may be configured to perform the functional elements described by the machine-executable code 606 sequentially, concurrently (e.g., on one or more different hardware platforms), or in one or more parallel process streams.

When implemented by logic circuitry 608 of the processors 602, the machine-executable code 606 is configured to adapt the processors 602 to perform operations of embodiments disclosed herein. For example, the machine-executable code 606 may be configured to adapt the processors 602 to perform at least a portion or a totality of the method 300 of FIG. 3 and/or the method 400 of FIG. 4. As another example, the machine-executable code 606 may be configured to adapt the processors 602 to perform at least a portion or a totality of the operations discussed for the servers 114 of FIG. 1, the IDPs 106a-106c of FIG. 1, and/or the IDPs 206a-206c of FIG. 2. As a specific, non-limiting example, the machine-executable code 606 may be configured to adapt the processors 602 to implement IDP mesh networks according to various embodiments disclosed herein. As another specific, non-limiting example, the machine-executable code 606 may be configured to adapt the processors 602 to implement the superapp 110 of FIG. 1.

The processors 602 may include a general-purpose processor, a special-purpose processor, a central processing unit (CPU), a microcontroller, a programmable logic controller (PLC), a digital signal processor (DSP), an application specific integrated circuit (ASIC), a field programmable gate array (FPGA) or other programmable logic device, discrete gate or transistor logic, discrete hardware components, other programmable devices, or any combination thereof designed to perform the functions disclosed herein. A general-purpose computer including a processor is considered a special-purpose computer while the general-purpose computer is configured to execute functional elements corresponding to the machine-executable code 606 (e.g., software code, firmware code, hardware descriptions) related to embodiments of the present disclosure. It is noted that a general-purpose processor (may also be referred to herein as a host processor or simply a host) may be a microprocessor, but in the alternative, the processors 602 may include any conventional processor, controller, microcontroller, or state machine. The processors 602 may also be implemented as a combination of computing devices, such as a combination of a DSP and a microprocessor, a plurality of microprocessors, one or more microprocessors in conjunction with a DSP core, or any other such configuration.

In some embodiments the storage 604 includes volatile data storage (e.g., random access memory (RAM)), non-volatile data storage (e.g., Flash memory, a hard disc drive, a solid state drive, erasable programmable read only memory (EPROM), etc.). In some embodiments the processors 602 and the storage 604 may be implemented into a single device (e.g., a semiconductor device product, a system on chip (SOC), etc.). In some embodiments the processors 602 and the storage 604 may be implemented into separate devices.

In some embodiments the machine-executable code 606 may include computer-readable instructions (e.g., software code, firmware code). By way of non-limiting example, the computer-readable instructions may be stored by the storage 604, accessed directly by the processors 602, and executed by the processors 602 using at least the logic circuitry 608. Also by way of non-limiting example, the computer-readable instructions may be stored on the storage 604, transferred to a memory device (not shown) for execution, and executed by the processors 602 using at least the logic circuitry 608. Accordingly, in some embodiments the logic circuitry 608 includes electrically configurable logic circuitry 608.

In some embodiments the machine-executable code 606 may describe hardware (e.g., circuitry) to be implemented in the logic circuitry 608 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 608 may be described in an RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments the machine-executable code 606 may include an HDL, an RTL, a GL description, a mask-level description, other hardware description, or any combination thereof.

In embodiments where the machine-executable code 606 includes a hardware description (at any level of abstraction), a system (not shown, but including the storage 604) may be configured to implement the hardware description described by the machine-executable code 606. By way of non-limiting example, the processors 602 may include a programmable logic device (e.g., an FPGA or a PLC) and the logic circuitry 608 may be electrically controlled to implement circuitry corresponding to the hardware description into the logic circuitry 608. Also by way of non-limiting example, the logic circuitry 608 may include hard-wired logic manufactured by a manufacturing system (not shown, but including the storage 604) according to the hardware description of the machine-executable code 606.

Regardless of whether the machine-executable code 606 includes computer-readable instructions or a hardware description, the logic circuitry 608 is adapted to perform the functional elements described by the machine-executable code 606 when implementing the functional elements of the machine-executable code 606. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations configured to perform the actions of the module or component and/or software objects or software routines that may be stored on and/or executed by general-purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general-purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. A first software domain to participate in an identity provider (IDP) mesh network, the first software domain comprising:
one or more processors; and
one or more non-transitory computer-readable media having computer-readable instructions stored thereon, the computer-readable instructions configured to instruct the one or more processors to:
manage one or more first software applications of the first software domain; and
operate a first IDP to:
provide access to the one or more first software applications of the first software domain to first users registered with the first software domain responsive to first verified login credentials provided to the first IDP; and
federate, with a second IDP of a second software domain participating in the IDP mesh network, access of the first users to one or more second software applications of the second software domain responsive to the first verified login credentials.

2. The first software domain of claim 1, wherein the computer-readable instructions are further configured to instruct the one or more processors to provide access to the one or more first software applications of the first software domain to second users registered with the second software domain responsive to federation of the second IDP with the first IDP.

3. The first software domain of claim 2, wherein the computer-readable instructions are further configured to instruct the one or more processors to operate the first IDP to match user attributes of a second user provided by the second IDP during federation of the second IDP with the first IDP with registered user attributes associated with a registered first user of the first software domain to reduce duplications of registered users of the first software domain and the second software domain.

4. The first software domain of claim 1, wherein the computer-readable instructions are configured to instruct the one or more processors to operate the first IDP to federate, with a third IDP of a third software domain participating in the IDP mesh network, access of the first users to one or more third software applications of the third software domain responsive to the first verified login credentials.

5. The first software domain of claim 4, wherein the computer-readable instructions are further configured to instruct the one or more processors to provide access to the one or more first software applications of the first software domain to third users registered with the third software domain responsive to federation of the third IDP with the first IDP.

6. The first software domain of claim 1, wherein at least one of the one or more first software applications or the one or more second software applications comprises a dealer management system software application.

7. The first software domain of claim 1, wherein the computer-readable instructions are configured to instruct the one or more processors to operate the first IDP to provide user attributes of a first user to the second IDP during a federation of the first IDP to the second IDP to enable the second IDP to reduce duplications of registered users of the first software domain and the second software domain.

8. The first software domain of claim 1, wherein the first IDP is communicatively coupled with all other IDPs of the IDP mesh network.

9. The first software domain of claim 1, wherein the IDP is communicatively coupled with only a subset of other IDPs of the IDP mesh network.

10. The first software domain of claim 1, wherein user provisioning from the first IDP to the second IDP is on.

11. The first software domain of claim 1, wherein user provisioning from the first IDP to the second IDP is off.

12. The first software domain of claim 1, wherein user provisioning from the second IDP to the first IDP is on.

13. The first software domain of claim 1, wherein user provisioning from the second IDP to the first IDP is off.

14. One or more servers, comprising:
a network interface to enable communication with a plurality of software domains arranged in an identity provider (IDP) mesh network; and
one or more processors communicatively coupled with the network interface, the one or more processors configured to operate a superapp to provide, to users, a platform for accessing software applications provided by the plurality of software domains responsive sign-on credentials for any one of the plurality of software domains.

15. The one or more servers of claim 14, wherein the software operations are automobile dealership software applications.

16. A method of operating an IDP mesh network, the method comprising:
receiving, by a first IDP of a first software domain via a user device, a request from a user registered with the first software domain to access a second software application of a second software domain; and
initiating, by the first IDP, federation with a second IDP of the second software domain to obtain, for the user, access to the second software application.

17. The method of claim 16, further comprising:
transmitting, by the first IDP, an assertion to a custom trusted endpoint representing the second IDP;
determining, by the second IDP, whether a sender of the assertion is trusted, whether the assertion is valid, and whether the user has access to the requested second software application; and
minting, by the second IDP, an access token for the user to access the one or more second software applications responsive to determining that the assertion sender is trusted, that the assertion is valid, and that the user has access to the requested second software application.

18. The method of claim 17, further comprising:
redirecting, by the second IDP, the user device to provide the requested second software application using the access token; and
launching the requested second software application at the user device.

19. The method of claim 17, wherein the assertion comprises a security assertion markup language (SAML) assertion.

20. The method of claim 16, further comprising redirecting, by the first IDP, the user device to display a login graphical user interface to receive login credentials from the user responsive to receiving the request from the user to access the second software application.
